(19) United States
(12) Patent Application Publication
(10) Pub. No.: US 2014/0119344 A1
(43) Pub. Date: May 1, 2014

(54) ADAPTIVE ALLOCATION OF IDLE SLOTS BASED ON ERROR RATE

(71) Applicant: QUALCOMM INCORPORATED, San Diego, CA (US)

(72) Inventors: Wei Zhang, San Diego, CA (US); Tom Chin, San Diego, CA (US); Kuo-Chun Lee, San Diego, CA (US)

(73) Assignee: QUALCOMM Incorporated, San Diego, CA (US)

(21) Appl. No.: 13/665,652

(22) Filed: Oct. 31, 2012

(51) Int. Cl. H04W 72/04

(52) U.S. Cl. 370/336

(57) ABSTRACT

To create additional communication gaps for a user equipment to perform inter-radio access technology (inter-RAT) measurement, the user equipment may discontinue communications during time slots of specific transmission time intervals (TTIs) based on a block error rate of a previous TTI. The time of the discontinued communications may then be allocated for inter-RAT measurement.

### BACKGROUND

1. Field

Aspects of the present disclosure relate generally to wireless communication systems, and more particularly, to creating idle intervals for inter-frequency measurement in a TD-SCDMA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

A method for wireless communication is offered. The method includes predicting a block error rate of at least one future transmission time interval (TTI) based on measured signal quality of a current TTI. The method also includes adaptively selecting a percentage of future TTIs to include in a measurement gap for performing signal measurement, based at least in part on the predicted block error rate.

An apparatus for wireless communication is offered. The apparatus includes means for predicting a block error rate of at least one future transmission time interval (TTI) based on measured signal quality of a current TTI. The apparatus also includes means for adaptively selecting a percentage of future TTIs to include in a measurement gap for performing signal measurement, based at least in part on the predicted block error rate.

A computer program product for wireless communication in a wireless network is offered. The computer program product includes a computer readable medium having non-transitory program code recorded thereon. The program code includes program code to predict a block error rate of at least one future transmission time interval (TTI) based on measured signal quality of a current TTI. The program code also includes program code to adaptively select a percentage of future TTIs to include in a measurement gap for performing signal measurement, based at least in part on the predicted block error rate.

An apparatus for wireless communication is offered. The apparatus includes a memory and a processor(s) coupled to the memory. The processor(s) is configured to predict a block error rate of at least one future transmission time interval (TTI) based on measured signal quality of a current TTI. The processor(s) is also configured to adaptively select a percentage of future TTIs to include in a measurement gap for performing signal measurement, based at least in part on the predicted block error rate.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a block diagram illustrating a transmission time interval with idle gaps for inter-frequency measurement.

FIG. 5 is a block diagram illustrating a normal transmission time interval with idle gaps for inter-frequency measurement and a modified transmission time interval with idle gaps for inter-frequency measurement.

FIG. 6 is a block diagram illustrating a method for creating idle gaps for inter-frequency measurement according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

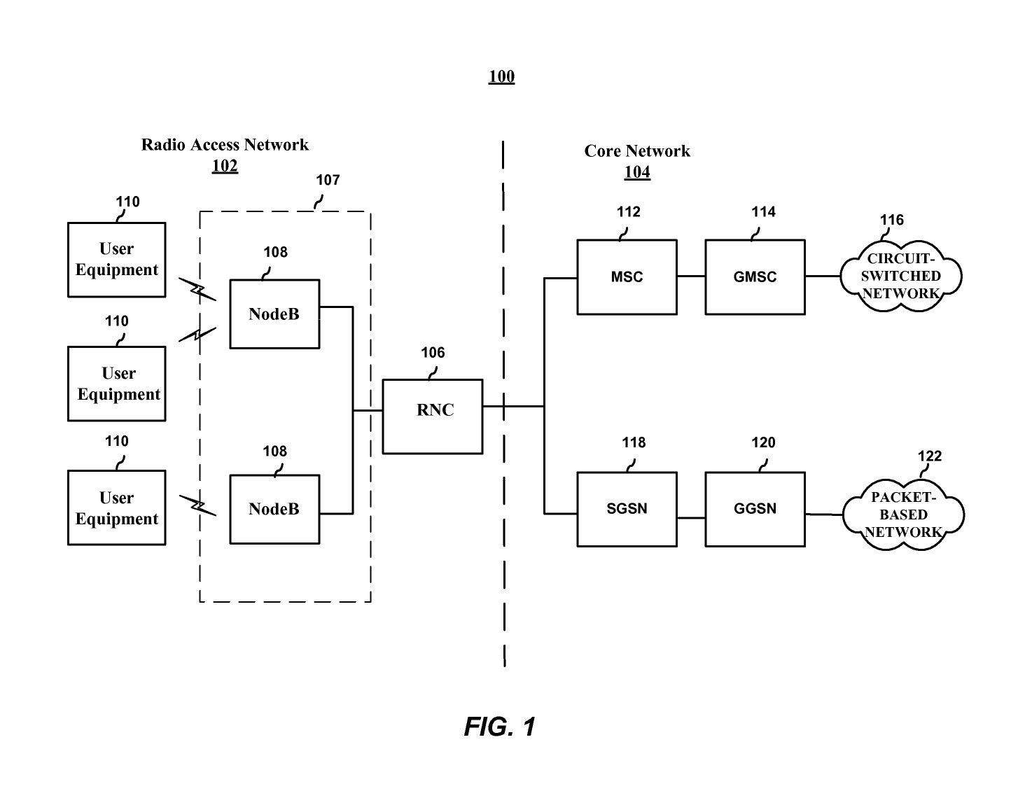

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

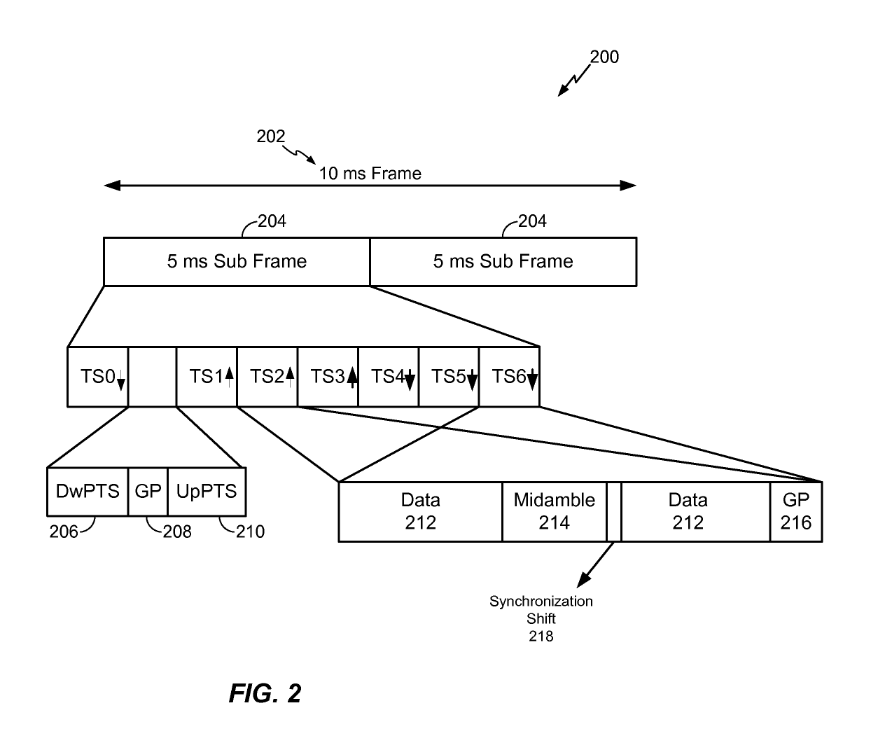

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

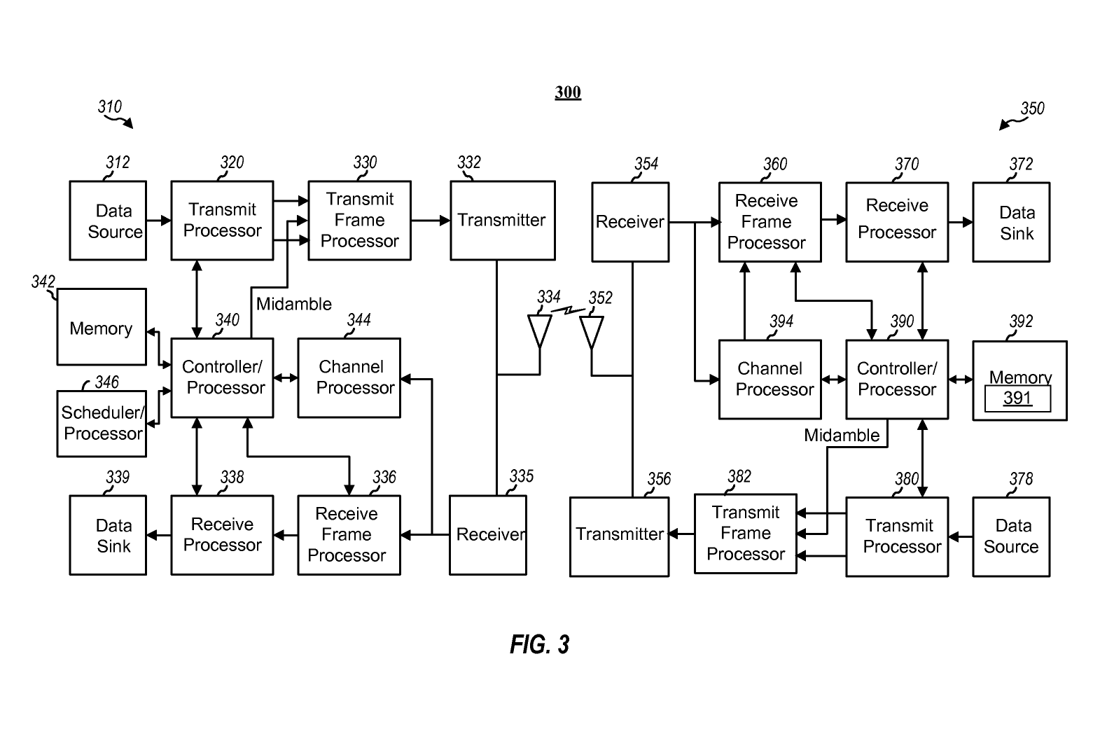

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store idle gap modification module 391 which, when executed by the controller/processor 390, configures the UE 350 for adaptively adding idle slots for inter-RAT measurement. A scheduler/processor 346 at the node B 310 may be used to allocate resources to the UEs and schedule downlink and/or uplink transmissions for the UEs.

Adaptive Allocation of Idle Slots Based on Error Rate

During wireless communication operation, a UE may periodically measure the signal strength of the serving cell as well as neighboring cells. The neighboring cells may be of the same radio access technology (RAT) that the UE is currently connected to, for example, TD-SCDMA, or they may be of different RATs. Such signal measurements may be referred to as inter-RAT for measurement of cells of different RATs or inter-frequency measurements or intra-RAT measurements for measurement of different cells of a same RAT. These inter-RAT measurements may be used to determine whether a UE should handover to a different cell or different network to improve performance.

In particular, the UE measures the RSCP (Receive Signal Code Power), and detects CIR (Carrier Interference Ratio) and SIR (Signal Interference Ratio) of the P-CCPCH (Primary Common Control Physical Channel) which is transmitted in TS0 of each subframe. In TD-SCDMA systems, the serving cell and neighbor cells are synchronized (i.e. all node Bs transmit the radio frames at the same time) so that the UE only needs to measure signal strength of neighbor cells at TS0 of the serving cell.

The result of the RSCP measurement may be random, as may be the BLER (Block Error Rate) experienced by the UE. However, the two (RSCP and BLER) may have a certain correlation which the UE may track. The historic correlation information may be stored in the UE. For example, the UE may save a correlation between RSCP and BLER in a table such one illustrated in Table 1:

TABLE 1

| RSCP (dBm) | BLER |
|---|---|
| −60 | 1% |
| −65 | 2% |
| −85 | 4% |
| −90 | 10% |
| −95 | 15% |
| −98 | 20% |

The UE may measure the RSCP at TS0 of one transmission time interval (TTI) and use the RSCP value to predict the BLER of the following received TTI(s). A TTI is a transmission duration (i.e., subframe) for the wireless communications. For example, if a RSCP at a first TTI is −85 dBm, the UE may predict that the BLER of a next TTI is approximately 4%.

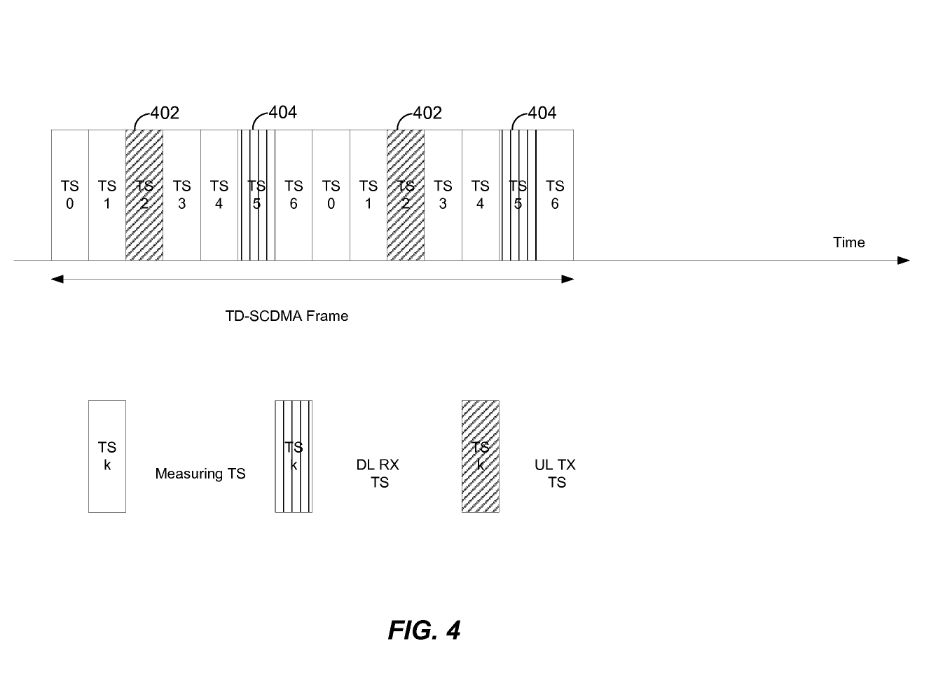

When the UE is in a connected state of a TD-SCDMA network, the UE measures the inter-RAT neighbor cells in GSM, WCDMA or LTE network as well as inter-frequency TD-SCDMA neighbor cells. If the UE is allocated only the DPCH (Dedicated Physical Channel), then there is typically one downlink timeslot and one uplink timeslot per subframe allocated for the UE to transmit and receive. The UE may use idle time slots to perform inter-RAT measurements. Those idle time slots, however, may not provide sufficient time to perform the desired inter-RAT measurements. For example, FIG. 4 shows the idle time slots for measurement when DPCH is allocated. Time slots 402 are allocated for downlink (DL)/receive (RX) communications. Time slots 404 are allocated for uplink (UL)/transmit (TX) communications. The remaining time slots are idle and may be allocated for measurement. Because communication time slots 402 and 404 are interspersed between the idle time slots, in the illustrated example, a gap no larger than three consecutive time slots is available for inter-RAT measurements.

Further, during HSPA (high speed packet access) operation, almost all time slots are configured for DPCH (Dedicated Physical Channel), HSDPA (high speed downlink packet access), or HSUPA (high speed uplink packet access) channels. There are almost no idle slots available for inter-frequency and inter-RAT measurement. Even if only DPCH is allocated to the UE, the UE may barely have sufficient idle time slots to perform inter-RAT measurements. The limited time available in the idle time slots may delay measurement which may hamper UE performance.

Offered is a method to use a predicted BLER to adaptively add additional idle slots for the UE to perform inter-RAT or inter-frequency measurement, and thus improve the overall UE call performance. Based on the predicted BLER, the UE may adaptively deactivate communications on certain time slots, thus choosing additional “idle” slots for IRAT measurement. Deactivating communications to create idle time slots, however, may increase the BLER experienced by the UE as the UE will lost time slots for communications. To reduce the impact to the UE, meaning to not deactivate so many communications so as to drastically impact UE performance, time slots may be chosen based on BLER as shown in the example of Table 2:

TABLE 2

| BLER | “Idle” slots chosen (TTI) |
|---|---|
| 1% | 1 of 200 |
| 2% | 1 of 100 |
| 4% | 2 of 100 |
| 10% | 5 of 100 |
| 20% | 10 of 100 |

In one aspect, when the BLER is low, the UE may choose fewer time slots for inter-RAT measurement than when the BLER is high. For example, when the projected BLER is 1%, for every 1 of 200 TTIs, the UE may increase the gap size by using all the downlink slots of the entire TTI (the 1 of 200 TTIs) to perform inter-RAT or inter-frequency measurement. The impact in this example is to increase BLER from 1% to 1.5%, a relatively small change in the BLER that is unlikely to significantly impact UE performance. When the projected BLER is 20%, for every 1 of 10 TTIs the UE may increase the gap and use all the downlink slots of the entire TTI (the 1 of 10 TTIs) to perform inter-RAT measurement. The impact in this example is to increase BLER from 20% to 30%. Although this is a larger jump in actual BLER, the relative BLER change is such that UE performance may not be significantly impacted. The number of adaptively selected idle slots in the examples above, based on the serving cell error conditions, are merely examples. Other values of idle slots chosen may be used. Other signal quality metrics beyond BLER may also be used.

The number of TTI selected to be “idle” may also depend on service occurring at the UE. If the on-going service is packet switched service, then upper layer packets may be retransmitted by a HARQ (hybrid automatic repeat request) or RLC (radio link control) layer and therefore a higher number of idle slots may be chosen. On the other hand, if the UE is engaged in circuit switched voice call service, the number of TTIs selected may be lower as compared to packet switched service. This method may allow a UE to have additional idle slots to perform inter-RAT or inter-frequency measurement.

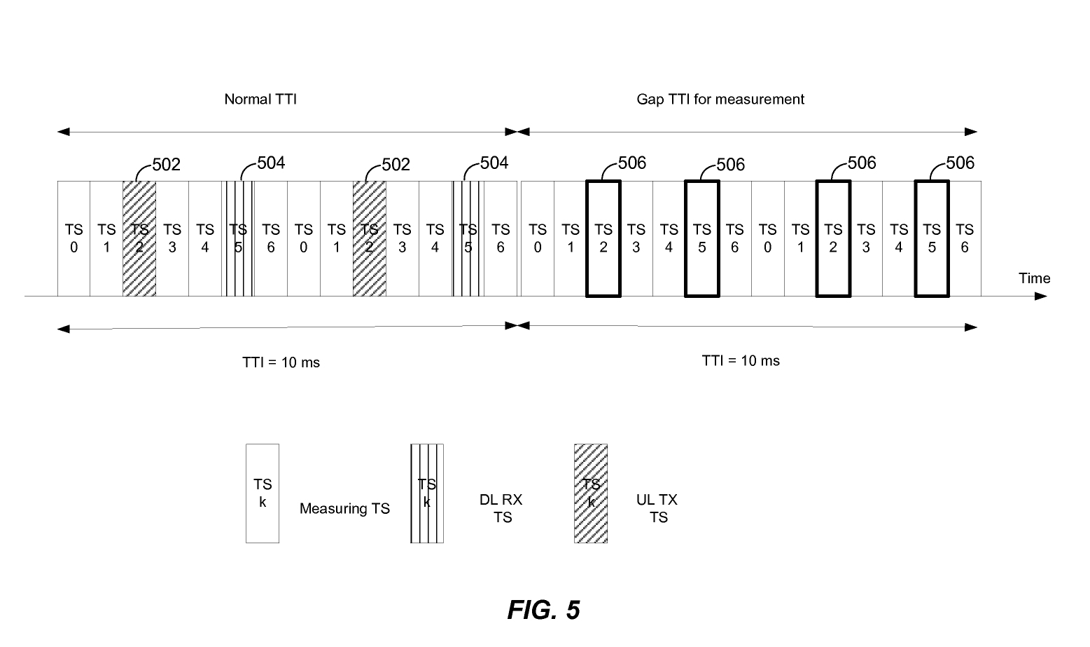

FIG. 5 shows assigning time slots from downlink or uplink transmission and making them available to the UE for other purposes, such as inter-RAT measurement. In a normal TTI, time slots 502 are allocated for downlink (DL)/receive (RX) communications and time slots 504 are allocated for uplink (UL)/transmit (TX) communications. When additional gaps are created, those time slots are made idle (shown as time slots 506) so the UE may perform inter-RAT measurement.

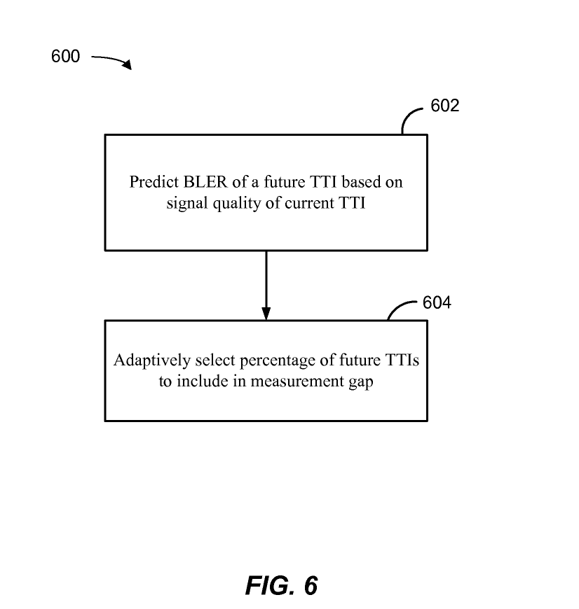

FIG. 6 shows a wireless communication method 600 according to one aspect of the disclosure. A UE may predict a block error rate (BLER) of at least one future transmission time interval (TTI) based on measured signal quality of a current TTI, as shown in block 602. The UE may also adaptively select a percentage of future TTIs to include in a measurement gap for performing signal measurement, based at least in part on the predicted block error rate, as shown in block 604.

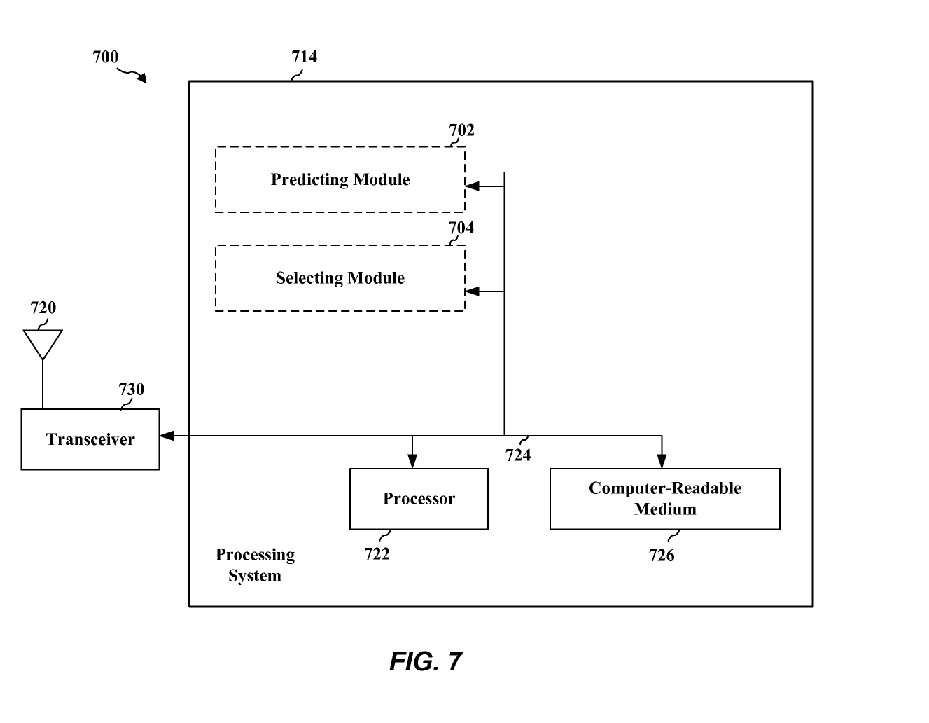

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702 and 704, and the computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a predicting module 702 for predicting a block error rate of at least one future transmission time interval (TTI) based on measured signal quality of a current TTI. The processing system 714 includes a selecting module 704 for adaptively selecting a percentage of future TTIs to include in a measurement gap for performing signal measurement, based at least in part on the predicted block error rate. The modules may be software modules running in the processor 722, resident/stored in the computer readable medium 726, one or more hardware modules coupled to the processor 722, or some combination thereof The processing system 714 may be a component of the UE 350 and may include the memory 392, and/or the controller/processor 390.

In one configuration, an apparatus such as a UE is configured for wireless communication including means for predicting and means for selecting. In one aspect, the above means may be the controller/processor 390, the memory 392, idle gap modification module 391, predicting module 702, selecting module 704 and/or the processing system 714 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
predicting a block error rate of at least one future transmission time interval (TTI) based on measured signal quality of a current TTI; and
adaptively selecting a percentage of future TTIs to include in a measurement gap for performing signal measurement, based at least in part on the predicted block error rate.

2. The method of claim 1, in which the adaptively selecting is further based at least in part on a service being performed by a user equipment.

3. The method of claim 2, in which the adaptively selecting decreases the percentage of future TTIs when circuit switched voice service is ongoing at the user equipment.

4. The method of claim 1, in which the signal measurement comprises inter-radio access technology measurement.

5. The method of claim 1, in which the signal measurement comprises intra-radio access technology measurement.

6. An apparatus for wireless communication, comprising:
means for predicting a block error rate of at least one future transmission time interval (TTI) based on measured signal quality of a current TTI; and
means for adaptively selecting a percentage of future TTIs to include in a measurement gap for performing signal measurement, based at least in part on the predicted block error rate.

7. The apparatus of claim 6, in which the means for adaptively selecting is further based at least in part on a service being performed by a user equipment.

8. The apparatus of claim 7, in which the means for adaptively selecting decreases the percentage of future TTIs when circuit switched voice service is ongoing at the user equipment.

9. The apparatus of claim 6, in which the signal measurement comprises inter-radio access technology measurement.

10. The apparatus of claim 6, in which the signal measurement comprises intra-radio access technology measurement.

11. An computer program product for wireless communication in a wireless network, comprising:
a computer-readable medium having non-transitory program code recorded thereon, the program code comprising:
program code to predict a block error rate of at least one future transmission time interval (TTI) based on measured signal quality of a current TTI; and
program code to adaptively select a percentage of future TTIs to include in a measurement gap for performing signal measurement, based at least in part on the predicted block error rate.

12. The computer program product of claim 11, in which the program code to adaptively select is further based at least in part on a service being performed by a user equipment.

13. The computer program product of claim 12, in which the program code to adaptively select decreases the percentage of future TTIs when circuit switched voice service is ongoing at the user equipment.

14. The computer program product of claim 11, in which the signal measurement comprises inter-radio access technology measurement.

15. The computer program product of claim 11, in which the signal measurement comprises intra-radio access technology measurement.

16. An apparatus for wireless communication, comprising:
a memory; and
at least one processor coupled to the memory and configured:
to predict a block error rate of at least one future transmission time interval (TTI) based on measured signal quality of a current TTI; and
to adaptively select a percentage of future TTIs to include in a measurement gap for performing signal measurement, based at least in part on the predicted block error rate.

17. The apparatus of claim 16, in which the at least one processor is configured to adaptively select further based at least in part on a service being performed by a user equipment.

18. The apparatus of claim 17, in which the at least one processor is configured to decrease the percentage of future TTIs when circuit switched voice service is ongoing at the user equipment.

19. The apparatus of claim 16, in which the signal measurement comprises inter-radio access technology measurement.

20. The apparatus of claim 16, in which the signal measurement comprises intra-radio access technology measurement.
